(19) United States
(12) Patent Application Publication
(10) Pub. No.: US 2018/0212838 A1
(43) Pub. Date: Jul. 26, 2018

(54) Intelligent Optical Network

(71) Applicant: Lynk Lab, Inc., Sebastopol, CA (US)

(72) Inventors: Eric T. Litvin, Sebastopol, CA (US); Jennifer A. Hawkins, Sebastopol, CA (US)

(21) Appl. No.: 15/873,831

(22) Filed: Jan. 17, 2018

Related U.S. Application Data
(60) Provisional application No. 62/447,334, filed on Jan. 17, 2017.

(51) Int. Cl. H04L 12/24

(52) U.S. Cl. CPC H04L 41/20; H04L 41/14; H04L 41/04; H04L 41/0213

(57) ABSTRACT

A link budget analysis dashboard collects and aggregates Layer 1 (Physical Layer) power levels from nodes of optical line systems (OLS) across the span of a backhaul or metro network. In one implementation, this is achieved by a cloud-based centralized network management platform written to poll the physical hardware layer to harvest optical power level data across a link span and subsequently organize, aggregate and present it to network engineer user as a real-time link budget analysis.

### CROSS-REFERENCE TO RELATED APPLICATION(S)

This application claims priority under 35 U.S.C. § 119(e) to U.S. Provisional Patent Application Ser. No. 62/447,334, “Intelligent Optical Network,” filed Jan. 17, 2017. The subject matter of all of the foregoing is incorporated herein by reference in their entirety.

### BACKGROUND

### 1. Technical Field

This disclosure relates to optical network intelligence and remote management of a disaggregated open line system (OLS) at the Layer 1, Physical Layer.

### 2. Description of Related Art

Traditional optical transport systems have been sold as a closed solution from a single vendor, meaning customers would buy the terminal equipment, the transmission equipment (amplifiers and reconfigurable optical add-drop multiplexers (ROADMs)) and network management system from one supplier. However, in the data center interconnect space, many customers are now demanding open optical line systems (OLSs). Among the advantages of open modular OLS are (a) avoiding single vendor lock-in, and (b) taking advantage of differing technological lifecycles. Typically, amplifiers and ROADMs remain relevant in networks for 4-6 years, while terminal equipment advances at a much more rapid pace with turnover of technology every 2-4 years. By using an open optical line system, customers have the added flexibility to choose best of breed at all times by simply upgrading a module of the OLS. Possible configurations of OLS' pluggable modules can provide optical layer muxing, optical channel monitoring (OCM), Erbium-doped fiber amplifier (EDFA) amplification, ROADM, and optical line protection.

However, as optical transport systems become larger and more complex containing equipment from multiple vendors, it also becomes increasingly difficult and expensive to monitor and maintain these systems. Thus, there is a need for improved approaches to monitoring and maintaining optical transport systems.

### BRIEF DESCRIPTION OF THE DRAWINGS

Embodiments of the disclosure have other advantages and features which will be more readily apparent from the following detailed description and the appended claims, when taken in conjunction with the examples in the accompanying drawings, in which:

FIGS. 1A and 1B illustrate an example of Layer 1 link for an optical network line system.

FIG. 2 shows a conceptual example of the remote network management software (NMS) platform interacting with the physical hardware.

FIG. 3 shows an NMS architecture, showing an example of collecting power level data across a link span to present a link budget analysis for a given link span.

FIGS. 4A-4C show examples of polling MIBS and link budget analysis dashboard.

### DETAILED DESCRIPTION OF THE PREFERRED EMBODIMENTS

The figures and the following description relate to preferred embodiments by way of illustration only. It should be noted that from the following discussion, alternative embodiments of the structures and methods disclosed herein will be readily recognized as viable alternatives that may be employed without departing from the principles of what is claimed.

One aspect of the invention relates to presenting a link budget analysis dashboard by collecting and aggregating Layer 1 (Physical Layer) power levels from nodes of optical line systems (OLS) across the span of a backhaul or metro network. In one implementation, this is achieved by a cloud-based centralized network management platform written to poll the physical hardware layer to harvest optical power level data across a link span and subsequently organize, aggregate and present it to network engineer user as a real-time link budget analysis.

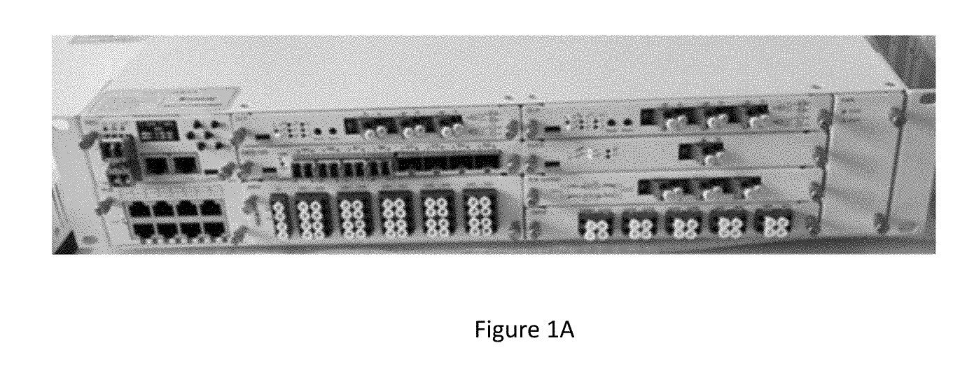

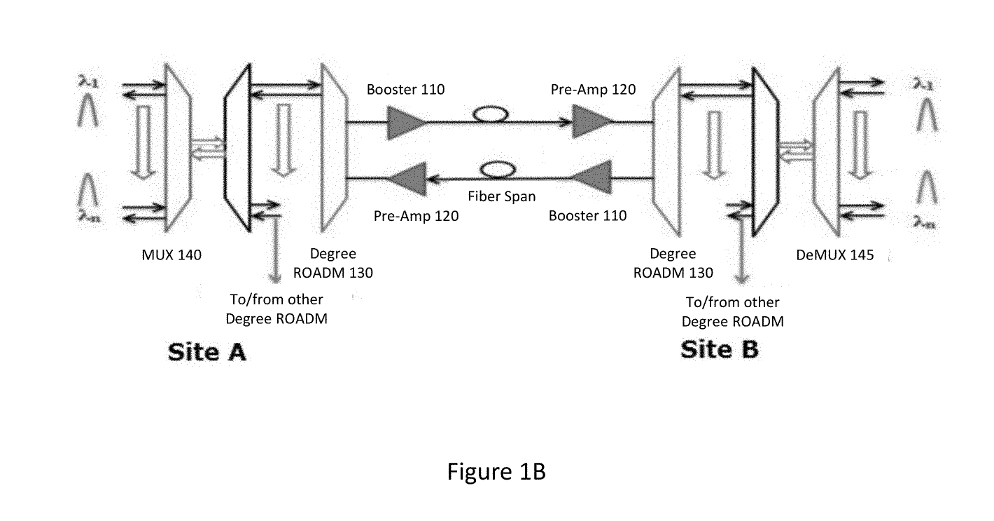

FIGS. 1A and 1B illustrates an example of Layer 1 link for a network line system. The image in FIG. 1A shows an example configuration of the OLS—a white box optical platform—which is an example of the apparatus according to one aspect of the invention.

The image of FIG. 1B shows an example link span where the OLS modules would be used with a combination of transmission modules—booster 110, pre-amp 120, dispersion compensation module (DCM, not shown), ROADM 130, and terminal modules like MUX 140 and DeMUX 145. It is a typical example of a point to point line system connecting two sites A and B. At each site would be a line system (1u, 2u, 4u, 8u) depending on what modules are needed. In the example below, the line system would contain a MUX 140 DeMUX 145, ROADM 130, booster amp 110 and pre amp 120.

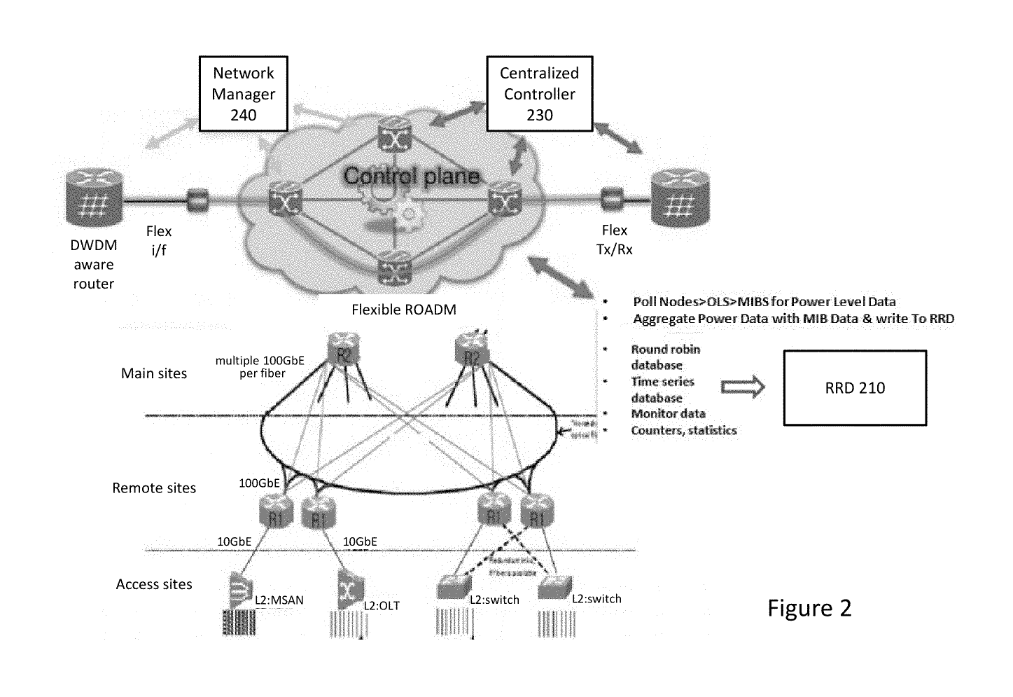

FIG. 2 shows a conceptual example of the remote network management software (NMS) platform interacting with the physical hardware. This example includes spatial Round Robin Database (RRD 210)—visualizer, control plane 220, centralized controller 230, and network manager 240. Discoverable nodes on link spans are visually presented in software platform as spatial/graphical, data-rich nodes. To aggregate and present a link budget analysis dashboard, an algorithm is invoked to poll the pluggable modules' Management Information Base (MIB) residing in the OLS. A MIB is a database used for managing the entities in a communication network. Most often associated with the Simple Network Management Protocol (SNMP).

In the FIG. 2 example, the system will discover OLS nodes using SNMP but triggered by syslog or SNMP trap or Link Layer Discovery Protocol (LLDP) to discover the neighbor nodes. Once the nodes across the span are populated, a spatial visualizer enables clickable nodes on the link span so the customer may select the clickable node to obtain node-specific data and performance metrics for the specific node relative to the entire link span. A desirable function in physical layer troubleshooting is the ability to retrieve input and output power levels from nodes across a span to pinpoint the root cause of optical power issues.

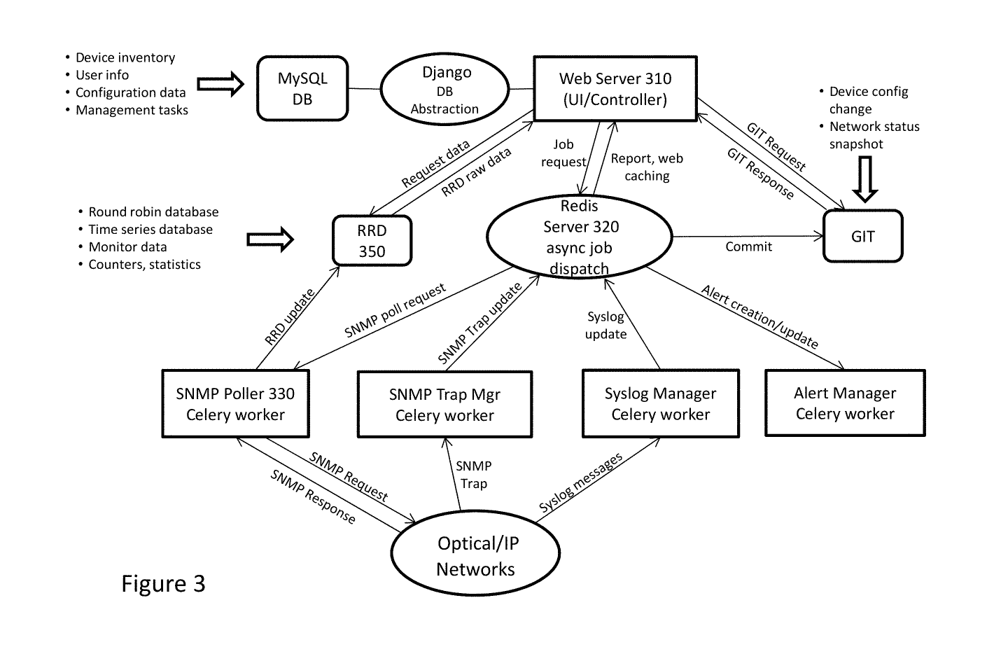

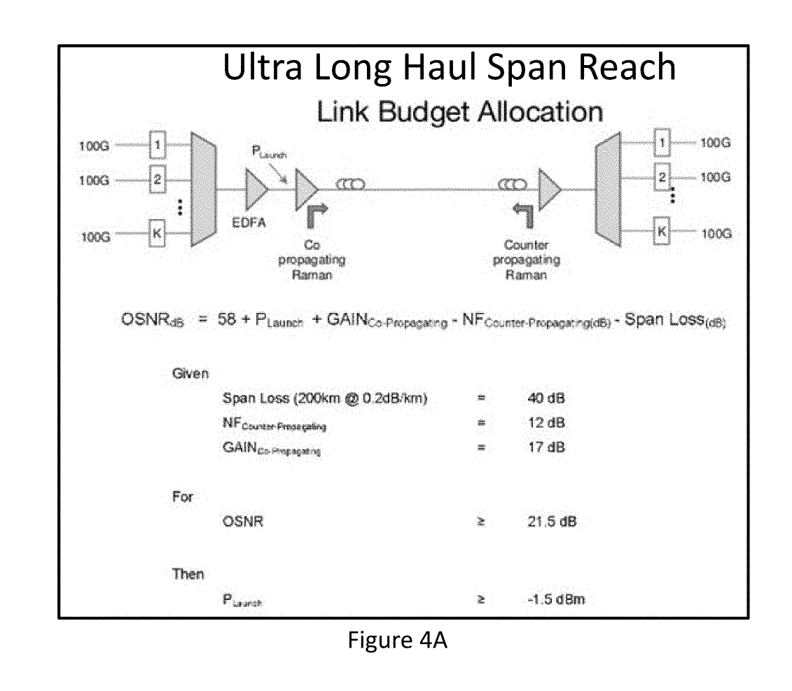

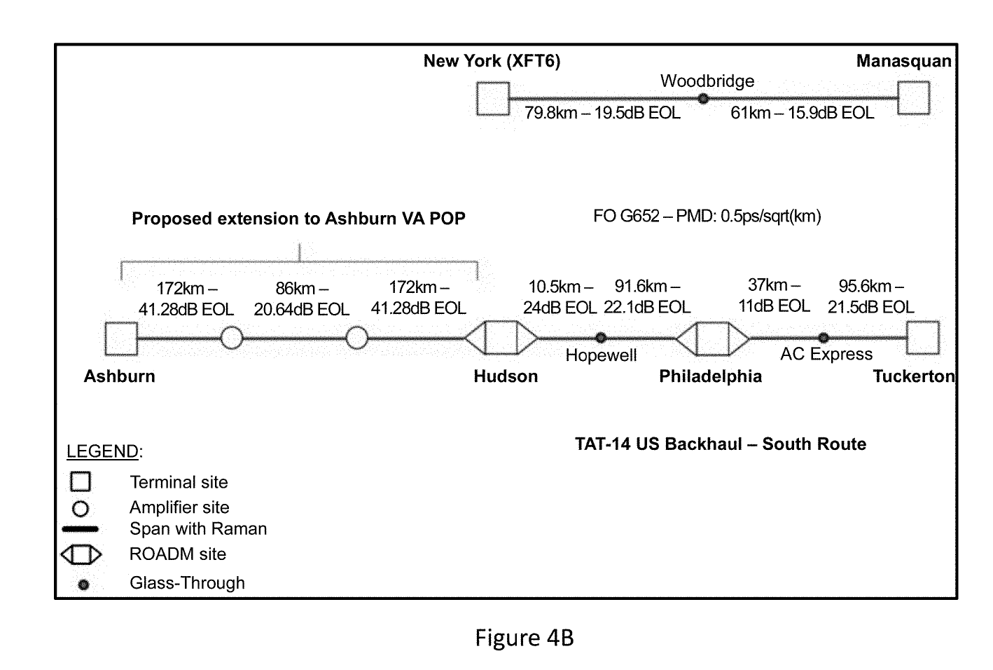

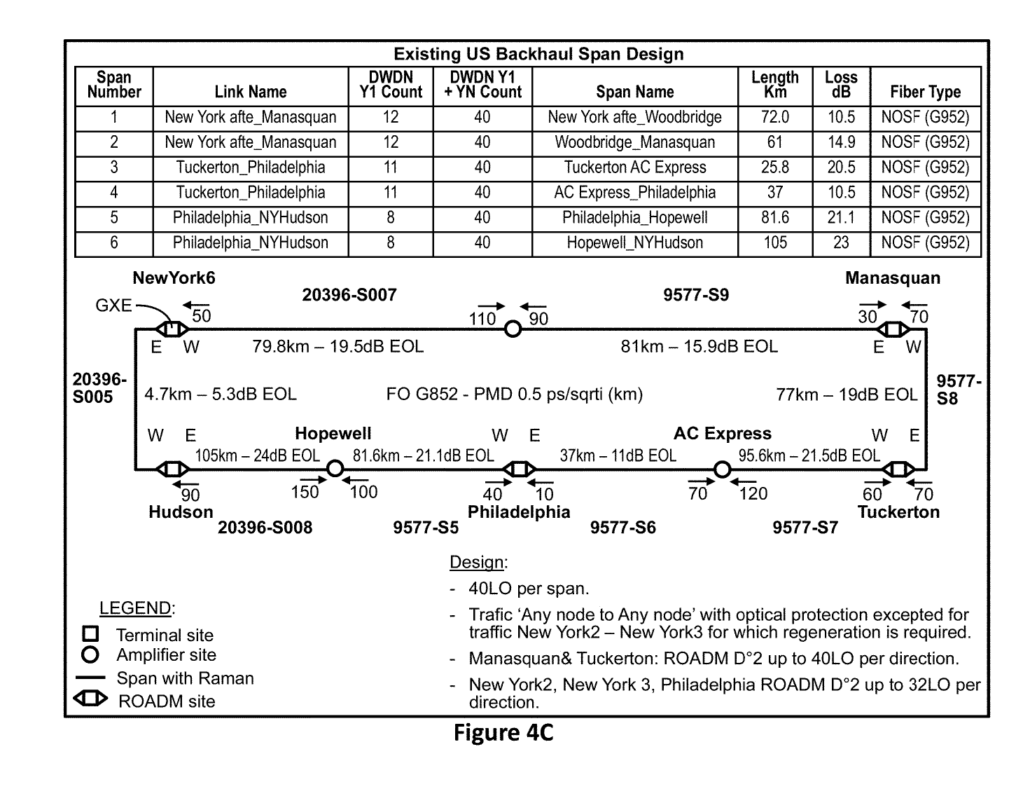

FIG. 3 illustrates the NMS architecture. It shows an example of collecting power level data across a link span to present a link budget analysis for a given link span. In this example, the web server (UI/Controller) 310 makes a job request of a Redis server 320, which asynchronously dispatches a polling job to a Celery worker instance 330 with the function of queuing and scheduling tasks among the eco-system of the discovered nodes/modules/MIBs. Additional system processing normalizes data format to make it vendor agonistic and writes the data to round robin database (RRD) 350 to provide time series charting, math and API as shown in FIG. 4.

The NMS architecture may be implemented in two phases. Phase I includes device information, status, logging; alert dashboard; user/group/token authentication; remote configuration management using vendor API; and MIB browser, SNMP polling, statistics and charting. Phase II includes discovery agent using SNMP; alert manager: alert subscription, rule management; Syslog manager: syslog filtering, alert creation, etc.; topology visualization; mobile UI using Reach Native; and REST API.

FIGS. 4A-4C show examples of polling MIBS and link budget analysis dashboard. FIG. 4A is a dashboard example of OSNR analysis for an ulta long haul span reach. In this example, the target transmission benchmark for 100G DWDM channels should be specified at OSNR of 21.5 to 22.0 dB with better than 10¹³ to 10¹⁵ BER performance. FIG. 4B is an example dashboard showing proposed extension of a link. In this example, non-linear fiber impairments resulting from high launch power when using EDFA approaches the span reach limit achievable on standard single mode fiber SMF-28 (G.652). FIG. 4C is an example dashboard showing a link budget analysis and planning example.

As shown in FIGS. 4A-4C link budget analysis dashboard examples, enabled by NMS architecture, OLS MIBS could be polled and power level data organized and written to RRD database. When user clinks on a link span in the graphical network visualizer (represented graphically via a user-interface), a graphical link span is presented. Power level data from the RRD is retrieved and aggregated into the link budget analysis and OSNR plan. FIGS. 4A-4C show a few examples of power level data being presented for a given link span. The link budget analysis can then be monitored over time since the RRD is date-time stamped and thus can present time-series data. Through the network visualizer graphical interface, users can click on network fiber links, zoom into nodes and corresponding virtual representation of the OLS units (represented graphically as nodes/icons) and a real-time link budget analysis will be displayed with power level data points comprising the layer 1, network architecture.

In the network engineering market, network engineers are skilled at the Layer 3 level, but these engineers typically are also assigned responsibility of physical network layer Layer 1 build-out. Essentially, Layer 3 people are tasked with solving Layer 1 problems. The NMS system described above can poll and harvest OLS-MIB data for Layer 1 optical power data and aggregating and reporting the Layer 1 data in a meaningful way so Layer 3 engineers can troubleshoot or monitor their networks.

When network operators assess availability on their network to accommodate growth, the underlying decisions that dictate viability of network growth typically is based on the data described above. As optical networks are built out over long fiber spans, signal amplification is necessary. As you amplify signals, noise is introduced and optical signal-to-noise ratio (OSNR) goes down. There are physical limitations to network growth based on the number of channels supported, insertion loss, the link span, the extent of amplification used. These data points are often important to Layer 3 network engineers and can be used to as a real-time decision support system to more effectively manage networks with link budget analysis, OSNR figures, and Bit Error Rate (BER) Analysis typically is available in a network console or dashboard.

Although the detailed description contains many specifics, these should not be construed as limiting the scope of the invention but merely as illustrating different examples. It should be appreciated that the scope of the disclosure includes other embodiments not discussed in detail above. Various other modifications, changes and variations which will be apparent to those skilled in the art may be made in the arrangement, operation and details of the method and apparatus disclosed herein without departing from the spirit and scope as defined in the appended claims. Therefore, the scope of the invention should be determined by the appended claims and their legal equivalents.

Alternate embodiments are implemented in computer hardware, firmware, software, and/or combinations thereof. Implementations can be implemented in a computer program product tangibly embodied in a machine-readable storage device for execution by a programmable processor; and method steps can be performed by a programmable processor executing a program of instructions to perform functions by operating on input data and generating output. Embodiments can be implemented advantageously in one or more computer programs that are executable on a programmable system including at least one programmable processor coupled to receive data and instructions from, and to transmit data and instructions to, a data storage system, at least one input device, and at least one output device. Each computer program can be implemented in a high-level procedural or object-oriented programming language, or in assembly or machine language if desired; and in any case, the language can be a compiled or interpreted language. Suitable processors include, by way of example, both general and special purpose microprocessors. Generally, a processor will receive instructions and data from a read-only memory and/or a random access memory. Generally, a computer will include one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM disks. Any of the foregoing can be supplemented by, or incorporated in, ASICs (application-specific integrated circuits) and other forms of hardware.

What is claimed is:

1. A remote network management software platform comprising:
a server that polls optical modules in an open optical line system for link power information;
a database in communication with the server, wherein the link power information is stored in the database; and
a user interface in communication with the database, wherein the user interface displays the link power information on a graphical representation of the open optical line system.
